(19) United States
(12) Patent Application Publication
(10) Pub. No.: US 2014/0134468 A1
(43) Pub. Date: May 15, 2014

(54) ELECTROCHEMICAL ENERGY STORAGE DEVICE WITH DATA TRANSMISSION, ARRANGEMENT AND METHOD

(71) Applicants: Deutsche ACCUmotive GmbH & Co. KG, Kirchheim/Teck-Nabern (DE); Li-Tec Battery GmbH, Kamenz (DE)

(72) Inventors: Tim SCHAEFER, Harztor (DE); Detlef DIEBALL, Dresden (DE)

(73) Assignees: Deutsche ACCUmotive GmbH & Co. KG, Kirchheim/Teck-Nabern (DE); Li-Tec Battery GmbH, Kamenz (DE)

(21) Appl. No.: 14/079,372

(22) Filed: Nov. 13, 2013

Related U.S. Application Data
(60) Provisional application No. 61/725,521, filed on Nov. 13, 2012.

(30) Foreign Application Priority Data
Nov. 13, 2012 (DE) 10 2012 022 266.1

(51) Int. Cl. H01M 10/48; G08C 17/02

(52) U.S. Cl. CPC H01M 10/48; G08C 17/02
USPC 429/90; 340/870.01

(57) ABSTRACT

An electrochemical energy storage device (1) comprising a housing (2) at or on which at least one antenna (3, 4, 13, 14) is arranged and which is connected to a transmitter (7, 8, 9, 10) of electromagnetic waves disposed in the interior of the housing. The transmitter is thereby equipped to send messages containing information on the signals of at least one sensor arranged within the interior of the housing

The present invention relates to an electrochemical energy storage device having data transmission, particularly an electrochemical energy storage device operating on the basis of lithium ions, as well as a method for transmitting data in conjunction with an electrochemical energy storage device and an arrangement for realizing such a method.

Among other things, the transmission of data between electrochemical energy storage devices and their environment plays an important role in so-called battery management, thus in the monitoring and regulating of electrochemical energy storage devices, for example a rechargeable battery or an accumulator system. Battery management thereby occurs on a regular basis by means of so-called battery management systems. U.S. Pat. No. 7,750,639 B2 discloses one such battery management system for large stationary batteries as used for example to realize so-called uninterrupted power supplies (backup power).

The objective to be accomplished by the present invention is that of improving where possible on known technical solutions for transmitting data between electrochemical energy storage devices and their environment.

This objective is accomplished respectively by a product according to one of the independent product claims and a method according to one of the independent method claims. The subclaims are to protect advantageous further developments of the present invention.

The invention provides an electrochemical energy storage device having a housing at or on which at least one antenna is arranged and which is connected to a transmitter of electromagnetic waves disposed in the interior of the housing. The transmitter is equipped to send messages which contain data collected or to be collected by at least one sensor arranged within the interior of the housing.

In the terms of the present invention, an electrochemical energy storage device is to be understood as a device which stores energy in chemical form and can release it to a load, i.e. an energy sink, in electrical form. A rechargeable electrochemical energy storage device can moreover receive energy from an energy source in electrical form and store it in chemical form. Electrochemical energy storage devices are single galvanic cells or arrangements of multiple galvanic cells. The latter are also called batteries, although this term is also frequently used for individual galvanic cells.

With respect to galvanic cells, also referred to simply as “cells” in the following, differentiation is made between primary cells and secondary cells. Primary cells indicate galvanic cells which cannot be recharged again after being discharged. Secondary cells, also called accumulators or simply “batteries,” are galvanic cells which can be recharged after being discharged. When an accumulator is charged, electrical energy is converted into chemical energy. When a load is connected, the chemical energy is then reconverted back into electrical energy again.

An electrochemical energy storage device according to the invention comprises an electrode assembly. In the terms of the invention, an electrode assembly is to be understood as a device which serves in particular in supplying electrical energy. The electrode assembly is preferably designed to in particular convert stored chemical energy into electrical energy before the electrode assembly makes said electrical energy available to a load. The electrode assembly is preferably also designed to convert supplied electrical energy into chemical energy and to store it as chemical energy. This is then also referred to as a rechargeable electrode assembly.

The electrode assembly comprises at least two electrodes of differing polarity (first and second electrodes in the sense of the invention). Preferably each of the electrodes of the electrode assembly comprise an in particular metallic collector film as well as one or two active masses. The active masses are preferably deposited on one or both sides of the collector films. Two active masses of different polarity are disposed on different areas of the collector film and spaced apart from each other by the collector film.

Electrons are exchanged between the collector film and the active mass(es) when the electrode assembly is charged or discharged. Preferably the collector film comprises the materials copper and/or aluminum. Preferably one or more conductor tabs are particularly materially connected to the collector film, preferentially formed integrally. Preferably the electrode assembly is preferentially materially connected to two current conducting devices of different polarity particularly by means of the conductor tabs of the electrodes, this serving in electrically connecting the electrode assembly to at least one electrode assembly of an adjacent energy storage cell and/or at least indirectly the electrical connection to battery terminals.

The electrodes of differing polarity of the electrode assembly are preferably spaced apart by a separator, wherein the separator is conductive to ions, but not or only poorly to electrons. Preferably the separator contains at least a part of the electrolyte and/or the conducting salt. Preferably the electrolyte is formed substantially without liquid content, particularly after the energy storage cell is sealed. Preferably the conducting salt comprises lithium ions. It is particularly preferential for lithium ions to be stored, or intercalated respectively, in the negative electrode during charging and to be released again during discharging.

Preferably an electrochemical energy storage device according to the invention is in the form of an encapsulated galvanic cell or in the form of an encapsulated assembly of a plurality of galvanic cells. In the terms of the present invention, an encapsulated galvanic cell, or an encapsulated assembly of a plurality of galvanic cells respectively, refers to a galvanic cell or a plurality of galvanic cells in which a housing, also occasionally referred to in technical terminology as packaging (“bag” or “coffee bag”), completely or partially shields the electrochemically active part of the electrochemical energy storage device from environmental influences from the outside world or from exchanging energy or matter. The walls or individual walls of the housing preferably contain foils, particularly preferably metallic films, which are preferably also arranged in multiple layers in areas one above the other. Some or one of these foils are/is preferably a functional film for or with a special data exchange region. Preferably an antenna or a plurality of antennas is/are embedded into a foil or into a functional film.

Preferably, a completely or sectionally electrically conductive, particularly preferably metallic film is configured as an electrical terminal contact of the electrochemical energy storage device. In some applications, this thereby enables a particularly simple electrical contacting of individual energy storage devices within a battery of multiple energy storage devices which can be created preferably by stacking a plurality of energy stores atop or next to one another.

In the terms of the present invention, a terminal contact of the electrochemical energy storage device is to be understood as an electrical conductor which is connected to an electrode or to a plurality of electrodes of one polarity in electrically conductive fashion and provided to electrically connect said electrode or electrodes to the outside environment of the electrochemical energy storage device.

Preferably disposed within the housing of the energy storage device is at least one preferably electronic sensor which measures the operating parameters of the energy storage device and provides the measurement results preferably in the form of digital data to a transmitter which is likewise disposed within the housing of the energy storage device. Preferably at least one sensor is embedded into a separator material or arranged on a surface of a separator material. Such a sensor preferably measures the concentration(s) of one or more chemical species such as ions, atoms or molecules, the temperature, the pressure, the electric field strength or another physical variable in the environment of the sensor suited to characterizing the operating status of the energy storage device.

An operating parameter in the sense of the invention refers to a characteristic or characteristic property particularly of the secondary cell, which in particular
enables concluding a desired operational state of the secondary cell or its electrode assembly respectively, and/or
enables concluding a particularly unplanned and/or unwanted operational state of the secondary cell or its electrode assembly respectively, and/or
can be determined by a sensor, the sensor thereby being able to at least intermittently provide a signal, preferably an electrical voltage or an electric current, and/or
can be processed by a control device, particularly a cell control device, particularly able to be linked to a target value, particularly able to be linked to another of the detected operating parameters, and/or
enables information to be provided on the cell voltage, the cell current, the cell temperature, the internal pressure of the cell, the integrity, the release of a substance from the electrode assembly, the presence of a foreign substance particularly from the environment of the secondary cell and/or the state of charge, and/or
can anticipate the cell switching into another operational state.

The at least one sensor is designed to detect an operating parameter of the secondary cell, particularly from its electrode assembly, and provide it to the cell control device.

Preferably the sensor is designed as: voltage sensor, current sensor, temperature sensor and/or thermocouple, pressure sensor, a sensor of chemical substances, hereinafter referred to as “substance sensor,” gas sensor, liquid sensor, position sensor or acceleration sensor, wherein the sensors serve in particular in the detecting of operating parameters of the secondary cell, particularly the electrode assembly.

Preferably at least one sensor is designed as an ion-selective electrode (ISE) (R. P. Buck and E. Lindner (1994). “Recommendations for nomenclature of ion-selective electrodes,” Pure & App. Chem. 66 (12): 2527-2536. Doi:10.1351/pac199466122527. A. J. Bard and L. Faulkner (2000). Electrochemical Methods: Fundamentals and Applications. New York: Wiley. ISBN 978-0-471-04372-0. Eric Bakker and Yu Qin (2006). “Electrochemical sensors” Anal. Chem. 78 (12): 3965-3984. doi:10.1021/ac060637m. PMC 2883720. PMID 16771535. (Review article). D. W. Rich, B. Grigg and G. H. Snyder (2006) “Determining ammonium and nitrate using a gas sensing ammonia electrode.” Soil and Crop Science Society of Florida (Proceedings, Vol. 65):1-4). Such sensors are also known to one skilled in the art as a “specific ion electrode” (SIE). They convert the activity of a specific ion in a solution into an electrical potential which can be measured by means of a voltmeter, galvanometer or by means of a pH meter.

Preferably a sensor is in the form of a temperature sensor, particularly preferably configured in the form of an optical fiber designed or operable as a temperature sensor or in the form of a plurality of such optical fibers. Such optical fibers provide the advantage that, due to the low thermal capacity of the optical fibers, the temperature can be measured virtually without any time lag or measurement inertia respectively. This is advantageous for time-resolved monitoring of the operating temperature of the accumulator and for deriving a control variable for a battery management system, particularly a charge controller. Due to the small dimensions of an optical fiber, it can also be very precisely positioned at a point where particularly short-lived temperature changes are particularly pronounced.

Preferably a sensor or a transmitter is equipped with a data memory in which data detected by the sensor or sensor connected to the transmitter can be stored. Preferably a sensor measures data in time series and stores said time series in the data memory so that the transmitter can compile the stored data into one message and transmit it via an antenna of the inventive energy storage device, preferably at a time of particularly favorable conditions for the data transmission.

Preferably a sensor is realized together with a transmitter and/or receiver on only one chip; i.e. on an integrated electronic circuit. The size of the cited components can thereby be substantially reduced and integration into a flat separator is additionally facilitated.

The antenna provided according to the invention enables a transmitter arranged inside the energy storage device to also communicate wirelessly with a receiver outside of the energy storage device housing when said housing shields the interior of the energy storage device from an external electromagnetic field, for example because it has an electrically conductive, particularly metallic layer. Such metallic layers can preferably be designed as functional films comprising a functional layer, which is designed to be at least partly electrically conductive and connected in electrically conductive fashion to the at least one first electrode of the electrode assembly, and at least one electrical insulating layer, which separates the first functional layer from the electrode assembly in the normal operational state of the energy storage cell in a layer direction of the functional film.

Preferably at least one antenna is designed such that it can simultaneously serve as an electrical terminal contact of the electrochemical energy storage device. This measure keeps the structure of an energy storage device according to the invention particularly simple.

Preferably the antenna is integrated into a wall of the housing. It is particularly preferable for the antenna to take the form of a foil in or on the wall of the housing. Preferably the antenna is electrically insulated from other electrically conductive areas of the housing wall there may be which are not part of the antenna.

Preferably the transmitter is an RFID tag or comprises an RFID tag, the signals of which can be wirelessly read by a read-out device arranged externally of the housing. In the sense of the present invention, an RFID tag is to be understood as an active or passive radio frequency transponder. Passive transponders draw their energy from the electromagnetic field of a reader, which can also be a read/write unit. Active transponders have their own power supply.

In conjunction with the present invention, preferably frequencies between 30 and 500 kHz are thereby used for ranges under a meter. For higher ranges, preferably frequencies between 3 and 30 MHz or between 100 MHz and 6 GHz are used in conjunction with the present invention depending on the circumstances of the given application.

Preferably the transmitter is equipped to be wirelessly supplied with energy via a read-out device or a high frequency generator arranged externally of the housing. The energy in this case is coupled in as an external electromagnetic field via the antenna of the energy storage device. In this way it can also reach the transmitter and the sensor connected to the transmitter when the housing of the energy storage device is impermeable to electromagnetic fields.

Preferably the transmitter is provided with a transmitter housing or with a coating which enables the transmitter to be used within an electrochemical cell. The transmitter housing or coating thereby preferably incorporates a plastic material or a plurality of plastic materials which are chemically resistant enough to survive in the chemically aggressive environment inside an electrochemical cell. Preferably the transmitter housing or the coating comprises glass, ceramic, polyethylene or a combination of these materials.

The transmitter is preferably also designed as a receiver and particularly preferably equipped with a processor for processing data, in particular compressing, decompressing and/or encrypting and/or decrypting. This allows protecting the transmitted data against espionage and/or sabotage, particularly if the transmitted data is to be provided with a digital signature, which is preferably done by means of an asymmetrical encryption method. The processor can be also a component of a sensor.

The transmitter and/or receiver are preferably galvanically or capacitively coupled to an electrical conductor which is connected in electrically conductive fashion to an antenna of the energy storage device. Preferably, said electrical conductor is a connector, current collector or any electrode of the energy storage device.

In accordance with the invention, a method is also provided for wirelessly transmitting data collected by at least one sensor arranged within a housing of an electrochemical energy storage device to a receiver arranged externally of said housing by means of an electromagnetic wave transmitter arranged inside the housing and at least one antenna arranged at or on said housing.

Preferably the transmitter is an RFID tag or comprises an RFID tag, the signals of which can be wirelessly read by a read-out device arranged outside of the housing.

Preferably the transmitter is also or exclusively wirelessly supplied with energy via a read-out device or a high frequency generator arranged externally of the housing. Such embodiments of the invention are coupled with the advantage of the transmitter being able to partially or exclusively draw its energy via an antenna of the energy storage device. In these cases, the transmitter can be designed such that a flow of energy into the transmitter does not or only partially occurs through its housing or through connections which do not coincide with an electrical connection to an antenna of the energy storage device. The construction of the transmitter can hereby be simplified, preferably the number of connections reduced.

Preferably the transmitter is equipped to also or exclusively be supplied with energy by means of an energy source arranged within the housing. Preferably the transmitter is supplied with energy by means of an energy source arranged within the housing. Preferably the sensor is galvanically connected to unlike electrodes of the energy storage device such that the transmitter can draw energy from the potential difference of said unlike electrodes and thereby associated current flow. The energy flow into the transmitter is thereby preferably low versus the energy flow out of the energy storage device into the external energy sink supplied by the energy storage device.

Preferably a transmitter or a plurality of transmitters is/are also equipped with receivers or designed as a receiver so that a bidirectional exchange of data is possible between devices inside the cell and devices outside of the cell.

Furthermore provided according to the invention is an arrangement for realizing an inventive method using an inventive electrochemical energy storage device and a read-out device disposed externally of the housing.

Preferably said arrangement comprises a high frequency generator arranged outside of the housing. The high frequency generator produces a high frequency electromagnetic field which partly penetrates or can penetrate into the interior of the energy storage device via an antenna of the energy storage device and advances or can advance to the transmitter. In the transmitter, which is preferably designed as an RFID tag or preferably comprises an RFID tag, energy is drawn from the high frequency electromagnetic field received via the antenna and provided for the operation of the transmitter.

Preferably the secondary cell has a charging capacity of at least 3 ampere-hours [Ah], further preferentially at least 5 Ah, further preferentially at least 10 Ah, further preferentially at least 20 Ah, further preferentially at least 50 Ah, further preferentially at least 100 Ah, further preferentially at least 200 Ah, further preferentially 500 Ah at most. This design provides the advantage of improving the service life of the load supplied by the secondary cell.

Preferably a current of at least 50 A, further preferentially at least 100 A, further preferentially at least 200 A, further preferentially at least 500 A, further preferentially 1000 A at most, can be at least intermittently, preferably over at least one hour, drawn from the secondary cell. This design provides the advantage of improving the performance of the load supplied by the secondary cell.

Preferably the secondary cell can at least intermittently provide a voltage, in particular a terminal voltage, of at least 1.2 V, further preferentially at least 1.5 V, further preferentially at least 2 V, further preferentially at least 2.5 V, further preferentially at least 3 V, further preferentially at least 3.5 V, further preferentially at least 4 V, further preferentially at least 4.5 V, further preferentially at least 5 V, further preferentially at least 5.5 V, further preferentially at least 6 V, further preferentially at least 6.5 V, further preferentially at least 7 V, further preferentially 7.5 V at most. It is particularly preferential for the secondary cell to comprise lithium and/or lithium ions. This design provides the advantage of improving the secondary cell's energy density.

Preferably the secondary cell can be at least intermittently, in particular over at least one hour, operated at an ambient temperature of between −40° C. and 100° C., further preferentially between <20° C. and 80° C., further preferentially between −10° C. and 60° C., further preferentially between 0° C. and 40° C. This design provides the advantage of the most unrestricted possible disposing and/or utilizing of the secondary cell for supplying a load, particularly a motor vehicle or a stationary system and/or machine.

Preferably the secondary cell has a gravimetric power density of at least 50 Wh/kg, further preferentially at least 100 Wh/kg, further preferentially at least 200 Wh/kg, further preferentially less than 500 Wh/kg. Preferably the electrode assembly comprises lithium ions. This design provides the advantage of improving the secondary cell's energy density

In accordance with one preferred embodiment, the secondary cell is provided for installation into a vehicle having at least one electric motor. Preferably the secondary cell is provided for supplying said electric motor. It is particularly preferential for the secondary cell to be provided for at least intermittently supplying an electric motor of a hybrid or electric vehicle drive train. This design provides the advantage of improving the supplying of the electric motor.

In accordance with a further preferred embodiment, the secondary cell is provided for use in a stationary battery, in particular in a buffer memory, as a device battery, industrial battery or starter battery. Preferably the charging capacity of the secondary cell in these applications amounts to at least 3 Ah, particularly preferentially at least 10 Ah. This design provides the advantage of improving the supplying of a stationary load, particularly a stationary mounted electric motor.

In accordance with a first preferred embodiment, the at least one separator, which does not or only poorly conducts electrons, consists of an at least partially material-permeable substrate. The substrate is preferably coated on at least one side with an inorganic material. An organic material which is preferably implemented as a non-woven material is preferably used as the at least partially material-permeable substrate.

The organic material, which preferably contains a polymer and particularly preferably a polyethylene terephthalate (PET), is coated with an inorganic, preferably ion-conducting material, which is further preferably ion-conductive at a temperature range of −40° C. to 200° C. The inorganic material preferentially contains at least one compound from among the group of oxides, phosphates, sulfates, titanates, silicates, aluminosilicates of at least one of the elements Zr, Al, Li, particularly preferentially zirconium oxide. Zirconium oxide in particular serves the material integrity, nanoporosity and flexibility of the separator. Preferably the inorganic, ion-conducting material exhibits particles having a maximum diameter of less than 100 nm. This embodiment provides the advantage of improving the stability of the electrode assembly at temperatures above 100° C.

In accordance with a second preferred embodiment, the at least one separator, which does not or only poorly conducts electrons but which is conductive to ions, consists at least predominantly or completely of a ceramic, preferably an oxide ceramic. This embodiment provides the advantage of improving the stability of the electrode assembly at temperatures above 100° C.

The following will draw on preferred embodiments as well as the figures in describing advantages of the invention in greater detail

Shown are:

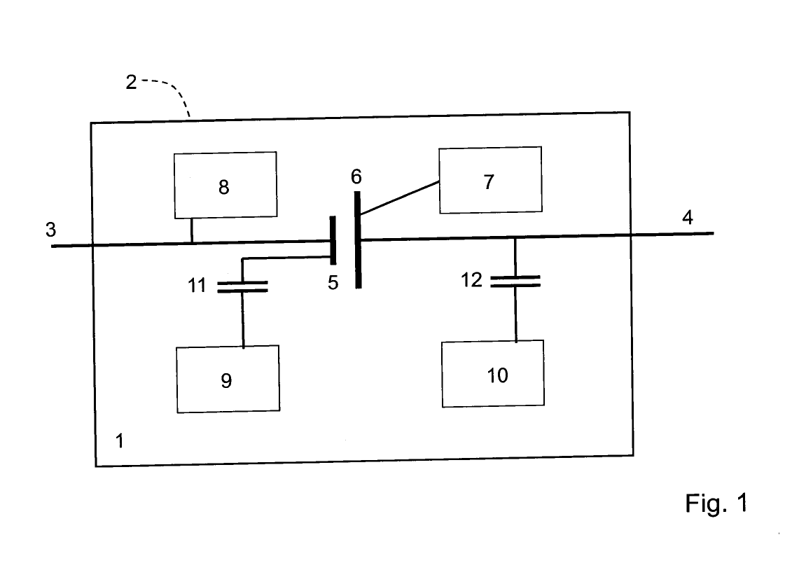

FIG. 1 a schematic view of an electrochemical energy storage device according to a first embodiment of the present invention;

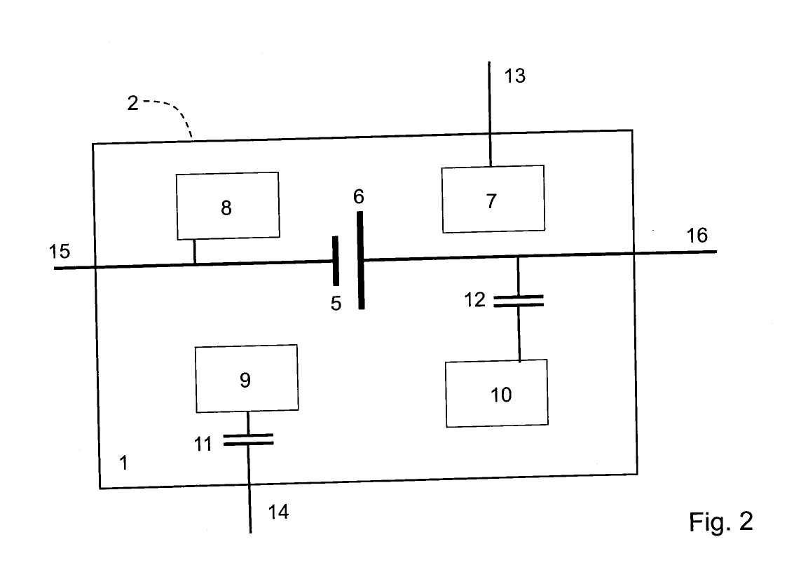

FIG. 2 a schematic view of an electrochemical energy storage device according to a second embodiment of the present invention;

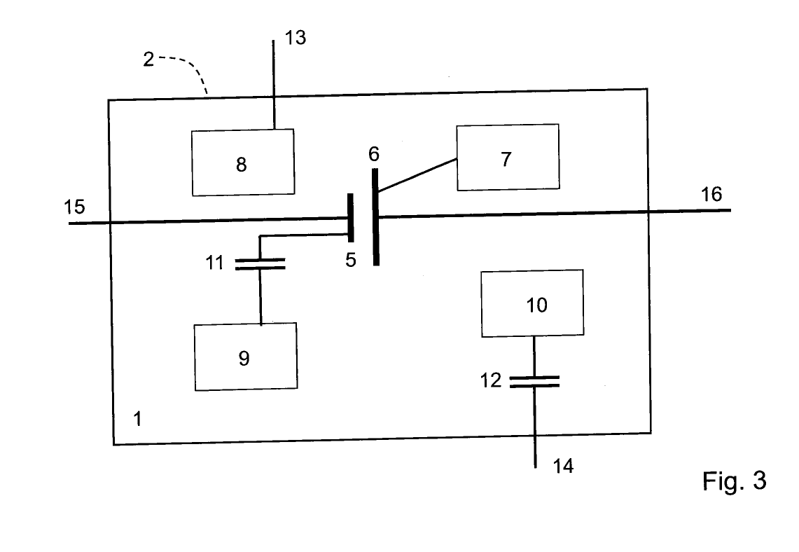

FIG. 3 a schematic view of an electrochemical energy storage device according to a third embodiment of the present invention.

The embodiment of the invention shown in FIG. 1 comprises an electrochemical energy storage device 1 having a housing 2, through which the terminal contacts 3 and 4 lead to the outside. Both terminal contacts 3 and 4 are also employed as antennas. The terminal contacts 3 and 4 are galvanically connected to electrodes 5 and 6 of unlike polarity. One transmitter 7 is galvanically connected to electrode 6. One transmitter 8 is galvanically connected to terminal contact 3.

One transmitter 9 is capacitive; i.e. connected to the electrode 5 by means of a capacitance 11. The capacitance 11 is dimensioned such that external high frequency electromagnetic fields coupled in via the terminal contact serving as antenna can be transmitted to the transmitter 9 via the capacitance with sufficient efficiency, and that high frequency electromagnetic fields can be radiated or emitted from the transmitter 9 to the outside via the capacitance with sufficient efficiency, preferably to a receiver arranged outside of the housing. One transmitter 10 is capacitive; i.e. connected to the terminal contact 4 by means of a capacitance 12. The capacitance 12 is dimensioned such that external high frequency electromagnetic fields coupled in via the terminal contact serving as antenna can be transmitted to the transmitter 10 via the capacitance with sufficient efficiency, and that high frequency electromagnetic fields can be radiated or emitted from the transmitter 10 to the outside via the capacitance with sufficient efficiency, preferably to a receiver arranged outside of the housing.

The present invention enables the wireless exchange of data from encapsulated galvanic cells impenetrable to electromagnetic fields or batteries of galvanic cells via one or more terminals, preferably by means of one or more RFID tags.

Alternatively or in combination therewith, data can be wirelessly exchanged by means of a special region of a functional film or by means of an antenna embedded into a functional film.

Electronic sensors and/or data elements in galvanic cells need a data port in order to read/write data. Particularly RFID tags can be applicably encased and/or coated so that they can be employed in the interior of a cell and thus provide the advantage of wired access not being needed for data exchange. Among other reasons, because of frequently high requirements as to cell tightness, particularly the housings of same, galvanic cells are housed in metallic housings and/or packagings which preferably contain a metallic layer. This impedes or prevents using RFID tags as transmitters, sensors and/or data elements inside the cell. The invention described herein provides the opportunity of economical wireless communication with devices inside the cell.

The transmitter, preferably an RFID tag, is thereto preferably galvanically or capacitively coupled to a connector 3, 4 or any given electrode 5, 6 of the cell. The signal can be contactlessly read at the terminal outside of the cell via the reader applicable to the RFID tag and/or at the bus bar of the battery's internal contacted cells. If necessary, the signal can be filtered out or extenuated by filters upstream of the battery terminals so that no internal information leaves the battery. A plurality of sensors and/or data elements within a cell, respectively a plurality of cells within a battery thus equipped, can transfer data by means of conventional network protocols (e.g. a collision-avoidance protocol).

Anti-collision techniques are procedures which enable the RFID tags to communicate simultaneously, whereby interference from multiple different signals is to be prevented. Anti-collision techniques regulate adherence to sequences and/or intervals of multi-transmitter access to shared data communication resources, for example by randomly distributed transmitting, so that the receiver can read out each transmitter individually. Preferably one of four basic types of anti-collision or multi-access procedures is used:
Space Division Multiple Access (SDMA); distances, range, antenna type and positioning are regulated so as to prevent collisions;
Time Division Multiple Access (TDMA); here access time is divided among users;
Frequency Division Multiple Access (FDMA); different frequencies are used here;
Code Division Multiple Access (CDMA); a shared frequency band can be used here.

Combinations of such methods can also be used. Preferential anti-collision techniques, particularly in the RFID field, are Slotted ALOHA, Adaptive Binary Tree and Slotted Terminal Adaptive Collection (STAC).

Correspondingly, the method according to the invention can be used with a battery having an HF-impermeable or HF-damping housing in order to exchange data with the interior of the battery via a terminal 3, 4. To this end, the reader is preferably contactlessly coupled via a terminal 3, 4 or the applicable connecting line respectively. The RFID tags contained within the battery interior couple preferably capacitively or galvanically to the internal bus bar upstream of the battery terminal.

The RFID tag can be supplied with energy for example by means of the reader, an external HF generator, an internal source or from the electrochemical process of the cell.

Analogously to this method, a flow of data can be transmitted out of and into the cell via an HF type of modulation to an electronic element integrated into the cell having an RFID tag similar to receiver and transmitter devices.

The embodiment of the invention shown in FIG. 2 exhibits an electrochemical energy storage device 1 having a housing 2, through which the terminal contacts 15 and 16 lead to the outside. One of said terminal contacts, terminal contact 16, is also employed as an antenna. The terminal contacts 15 and 16 are galvanically connected to electrodes 5 and 6 of unlike polarity. One transmitter 7 is galvanically connected to antenna 13.

One transmitter 9 is capacitive; i.e. connected to the antenna 14 by means of a capacitance 11. The capacitance 11 is dimensioned such that external high frequency electromagnetic fields coupled in via the antenna 14 can be transmitted to the transmitter 9 via the capacitance with sufficient efficiency, and that high frequency electromagnetic fields can be radiated or emitted from the transmitter 9 to the outside via the capacitance with sufficient efficiency, preferably to a receiver arranged outside of the housing. One transmitter 10 is capacitive; i.e. connected to the terminal contact 16, which concurrently serves as an antenna, by means of a capacitance 12. The capacitance 12 is dimensioned such that external high frequency electromagnetic fields coupled in via the terminal contact 16 serving as antenna can be transmitted to the transmitter 10 via the capacitance with sufficient efficiency, and that high frequency electromagnetic fields can be radiated or emitted from the transmitter 10 to the outside via the capacitance with sufficient efficiency, preferably to a receiver arranged outside of the housing.

The embodiment of the invention shown in FIG. 3 exhibits an electrochemical energy storage device 1 having a housing 2 through which the terminal contacts 15 and 16 lead to the outside. Neither of said terminal contacts is used as an antenna. The terminal contacts 15 and 16 are galvanically connected to electrodes 5 and 6 of unlike polarity. One transmitter 7 is galvanically connected to antenna 13.

One transmitter 10 is capacitive; i.e. connected to the antenna 14 by means of a capacitance 12. The capacitance 12 is dimensioned such that external high frequency electromagnetic fields coupled in via the antenna 14 can be transmitted to the transmitter 10 via the capacitance with sufficient efficiency, and that high frequency electromagnetic fields can be radiated or emitted from the transmitter 10 to the outside via the capacitance with sufficient efficiency, preferably to a receiver arranged outside of the housing:

The following list of reference numerals as employed is an integral part of the present patent application:
1 electrochemical energy storage device
2 housing, housing wall
3 antenna, terminal contact
4 antenna, terminal contact
5 positive electrode
6 negative electrode
7 transmitter
8 transmitter
9 transmitter
10 transmitter
11 capacitance
12 capacitance
13 antenna
14 antenna
15 terminal contact
16 terminal contact

1. An electrochemical energy storage device, comprising:
a housing at or on which at least one antenna is arranged and which is connected to a transmitter of electromagnetic waves disposed in the interior of the housing, wherein the transmitter is equipped to send messages which contain data collected or to be collected by at least one sensor arranged within the interior of the housing.

2. The electrochemical energy storage device according to claim 1, wherein at least one antenna is designed such that it can simultaneously serve as an electrical terminal contact of the electrochemical energy storage device.

3. The electrochemical energy storage device according to claim 1, wherein the antenna is integrated into a wall of the housing.

4. The electrochemical energy storage device according to claim 1, wherein the transmitter is an RFID tag or comprises an RFID tag, the signals of which can be wirelessly read by a read-out device arranged externally of the housing.

5. The electrochemical energy storage device according to claim 1, wherein the transmitter is equipped to be wirelessly supplied with energy via a read-out device or a high frequency generator arranged externally of the housing.

6. The electrochemical energy storage device according to claim 1, wherein the transmitter is equipped to be supplied with energy by means of an energy source arranged within the housing.

7. A method for the wireless transmission of data collected by at least one sensor arranged within a housing of an electrochemical energy storage device to a receiver arranged externally of said housing by an electromagnetic wave transmitter arranged inside the housing and at least one antenna arranged at or on said housing.

8. The method according to claim 7, wherein at least one antenna is designed such that it can simultaneously serve as an electrical terminal contact of the electrochemical energy storage device.

9. The method according to claim 7, wherein the antenna is integrated into a wall of the housing.

10. The method according to claim 7, wherein the antenna exhibits the form of a foil in or on the wall of the housing.

11. The method according to claim 7, wherein the transmitter is an RFID tag or comprises an RFID tag, the signals of which can be wirelessly read by a read-out device arranged externally of the housing.

12. The method according to claim 7, wherein the transmitter is supplied with energy via a read-out device or a high frequency generator arranged externally of the housing.

13. The method according to claim 7, wherein the transmitter is supplied with energy by means of an energy source arranged within the housing.

14. An arrangement for realizing a method in accordance with claim 7, comprising:
an electrochemical energy storage device and
a read-out device disposed externally of the housing;
wherein said electrochemical energy storage device, comprises:
said housing at or on which said at least one antenna is arranged and which is connected to said transmitter of electromagnetic waves disposed in the interior of the housing,
wherein the transmitter is equipped to send messages which contain data collected or to be collected by at least one sensor arranged within the interior of the housing.

15. The arrangement according to claim 14, comprising:
a high frequency generator arranged outside of the housing.

16. The electrochemical energy storage device according to claim 3, wherein the antenna exhibits the form of a foil in or on the wall of the housing.
